(19) United States
(12) Patent Application Publication
(10) Pub. No.: US 2007/0115927 A1
(43) Pub. Date: May 24, 2007

(54) Click to initiate secure network service

(75) Inventor: Larry B. Pearson, San Antonio, TX (US)

Correspondence Address: TOLER SCHAFFER, LLP, 8500 BLUFFSTONE COVE, SUITE A201, AUSTIN, TX, 78759, US

(73) Assignee: SBC Knowledge Ventures, LP, Reno, NV (US)

(21) Appl. No.: 11/267,594

(22) Filed: Nov. 4, 2005

(51) Int. Cl. H04L 12/66

(52) U.S. Cl. 370/352

(57) ABSTRACT

A computer is provided access to a page from a computer site without a login. The computer sends a first request to the computer site in response to a user-initiated action made using the page. The computer site generates a first redirect message based on the first request to redirect the computer to a server. The first redirect message encodes information that comprises a time stamp, and encodes a digital signature generated based on the information. The computer site sends the redirect message to the computer, which causes a second request to be sent to the server. Based on the second request, the server directs a service element to initiate the network service if the computer has an active session with the server and the information encoded in the second request is valid based on the digital signature.

### FIELD OF THE DISCLOSURE

The present disclosure relates to methods and systems for integrating Web sites with network services.

### BACKGROUND

Click-to-call is a feature of Voice over Internet Protocol (VoIP) services. The click-to-call feature is available through a helper application running on a user's desktop or directly from a VoIP portal. A secure click-to-call from a third-party Web site also can be implemented, but requires a large amount of integration work.

### BRIEF DESCRIPTION OF THE DRAWINGS

FIG. 1 is a block diagram of an embodiment of system to enable a user to initiate a network service from a third-party computer site;

FIG. 2 is a screen shot of an embodiment of a Web page provided by a third-party computer site and having a click-to-call control;

FIG. 3 is a screen shot of an embodiment of a page having a click-to-call control and an add-to-address-book control; and

FIG. 4 is an illustrative embodiment of a general computer system.

### DETAILED DESCRIPTION OF THE DRAWINGS

Disclosed herein are embodiments of a method for providing secure click-to-initiate features, such as a click-to-call feature or an add-to-address-book feature, from one or more computer sites. Using a redirect capability inherent in browsers such as Web browsers, the embodiments provide simple, secure and reliable communications between the computer sites and a network service provider. By making the click-to-initiate features user-selectable from third-party computer sites, the exposure of a network infrastructure provided by the network service provider is increased via a Web services platform. Further, the embodiments enable the click-to-initiate features to be implemented without a large amount of integration work.

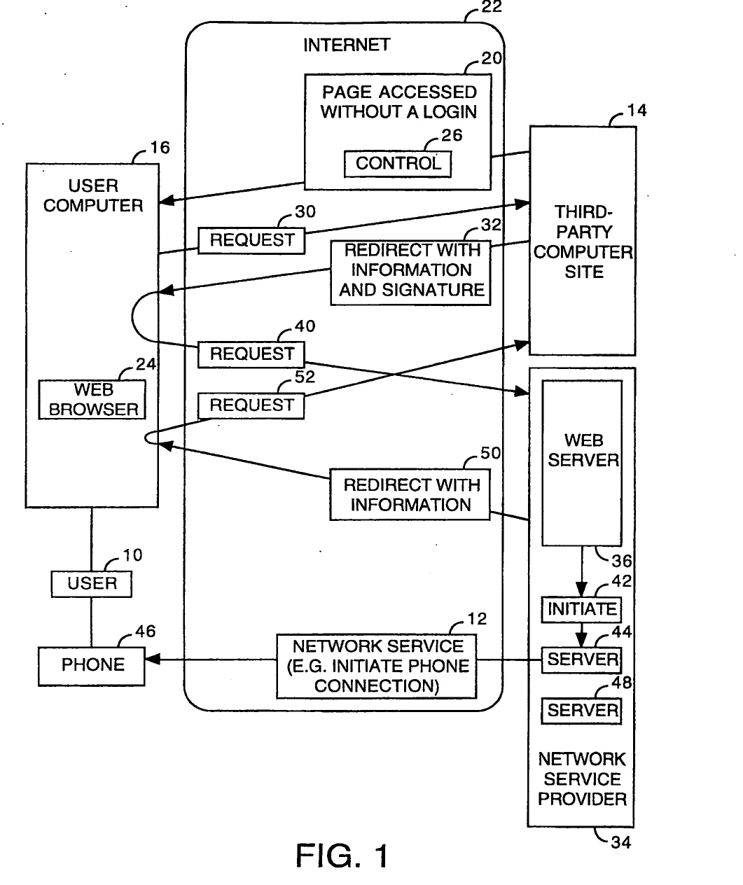

FIG. 1 is a block diagram of an embodiment of system to enable a user 10 to initiate a network service 12 from a computer site such as a third-party computer site 14. The third-party computer site 14 provides, to a user computer 16, access to a page 20 without requiring a login by the user 10. The user computer 16 accesses the page 20 via the Internet 22 or another computer network. The user computer 16 displays the page 20 using a client application such as a Web browser 24.

The page 20 includes a control 26 that is selectable by the user 10 to request initiation of the network service 12. In an embodiment, the third-party computer site 10 comprises a Web site, the page 20 comprises a Web page, and the control 26 comprises a user-selectable button, hyperlink or an HTML form.

In response to a user-initiated action made using the page 20, such as a user-initiated click of the control 26, a first request 30 is sent from the user computer 16 to the third-party computer site 14. The first request 30 may comprise a Hyper-Text Transfer Protocol (HTTP) request. The third-party computer site 14 receives the first request 30 via the Internet 22.

Based on the first request 30, the third-party computer site 14 generates a first redirect message 32. The first redirect message 32 is to redirect the user computer 16 to a network service provider 34 capable of initiating the network service 12. The first redirect message 32 encodes information and a digital signature that are usable by the network service provider 34. The information may comprise any combination of an action value, request-satisfying information, an identifier of the third party, a return address, and a time stamp.

The action value indicates a particular action to be taken by the network service provider 34. In an embodiment, the action value indicates which network service, from a plurality of different network services, is to be initiated by the network service provider 34. Examples of the different network services include, but are not limited to, a click-to-call service, a place-a-VoIP-telephone-call service, an add-to-address-book service, an initiate-download service (e.g. to initiate downloading of a movie, music or other content), and a modify-bandwidth-on-demand service (e.g. to initiate an on-demand increase of bandwidth for a digital subscriber line (DSL) service). For purposes of illustration and example, consider the action value indicating the network service 12.

The request-satisfying information comprises information needed by the network service provider 34 to satisfy the request. For example, if the action value identifies a network service of placing a VoIP call to a telephone number or adding a telephone number to an address book, the request-satisfying information may comprise the telephone number.

The identifier of the third party identifies either the third-party computer site 14 or an entity associated with providing the third-party computer site 14. The third party may be an affiliate or a partner of the network service provider 34, for example. In an embodiment, the identifier is an affiliate Web site identifier.

The return address indicates a computer address to which the user computer 16 is returned after completing the operation. The return address may comprise a return Uniform Resource Locator (URL) of the third-party computer site 14.

The time stamp indicates a time at or about which the first redirect message 32 is generated. The time stamp may be in a coordinated universal time such as Greenwich Mean Time (GMT).

The digital signature is generated based on some or all of the aforementioned information. Preferably, the digital signature is generated based on at least the time stamp. The digital signature can be generated by encrypting some or all of the aforementioned information. This act may comprise applying a one-way hash algorithm to concatenated parts of a first redirect URL (as subsequently described). The one-way hash algorithm uses a shared secret of the third party computer site 14 and the network service provider 34. The shared secret may be an encryption key known only by a Web server of the third-party computer site and a Web server 36 of the network service provider 34 that is to respond to the action. Examples of the one-way hash algorithm include, but are not limited to, SHA-1 and MD-5.

The first redirect message may comprise the first redirect URL, wherein the first redirect URL comprises a computer address of the network service provider 34, the information and the digital signature. The computer address, the information and the digital signature may be concatenated and separated by a delimiter in the URL. In some embodiments, the delimiter comprises either a slash “/”, an ampersand “&” or another character. In some embodiments, either a slash “/”, a question mark “?”, or another character delimits the information and/or the digital signature from the computer address.

The third-party computer site 14 sends the first redirect message 32 to the user computer 16, which in turn passes the first redirect message 32 to the network service provider 34. The Web browser 24 may act to receive the first redirect URL, and automatically pass the URL through HTTP to the Web server 36 of the network service provider 34. In this way, the first redirect message 32 is sent from the third-party computer site 14 through the Web browser 24 to the network service provider 34 in the form of a second request message 40. The network service provider 34 receives the second request message 40.

Based on the second request message 40, the network service provider 34 determines whether or not the user computer 16 has an active session with the network service provider 34. This act may comprise performing a cookie exchange between the network service provider 34 and the user computer 16 to determine whether or not the user is logged in to the network service provider 34.

If the session does not exist between the user computer 16 and the network service provider 34, a login user interface is provided to the user computer 16. The login user interface, which may comprise a login page, is sent either directly from the network service provider 34 or through a single sign-on (SSO) process. The SSO process may follow a Federated Identity Management (FIM) protocol and process like the Liberty Alliance Identity Federation Foundation (ID-FF).

The user 10 makes an input, such as a user identifier and a password, to the login user interface. If the user 10 is not authenticated based on the input, then an error message is sent to the user computer 14 and/or the user computer is redirected back to the requesting page 20 with an error code. The error message may comprise an HTML page that indicates the error to the user 10.

If the user computer 16 has an active session or if the user 10 has been authenticated using the login user interface, the time stamp embedded in the second request 40 is compared to a current time on the Web server 36 of the network service provider 34. If the difference between the time stamp and the current time is outside of a predetermined window, the second request 40 is deemed invalid. For example, the second request 40 may be deemed invalid if the difference between the time stamp and the current time is beyond a threshold such as one minute.

If the second request 40 is deemed invalid based on the time stamp, the network service provider 34 performs error handling and does not initiate the network service 12. Examples of the error handling include returning an error message to the user computer 16 and/or redirecting the user computer 16 back to the third-party computer site 14 with an error code embedded in the URL.

If the second request 40 has not been invalidated based on the time stamp, the network service provider 34 determines whether or not the information encoded in the second request 40 is valid based on the digital signature. This act may comprise the network service provider 34 encrypting information using the same encryption algorithm (e.g. the same one-way hash algorithm) used by the third-party computer site 14, and comparing the encrypted information to the digital signature. If the locally-computed digital signature differs from the third-party-computed digital signature, then the second request 40 is deemed invalid. Alternatively, this act may comprise the network service provider 34 decrypting the digital signature, and comparing the decrypted digital signature to the information. If the decrypted digital signature differs from the information, then the second request 40 is deemed invalid.

If the information in the second request 40 is deemed invalid, then the network service provider 34 performs error handling and does not initiate the network service 12. Examples of the error handling include returning an error message to the user computer 16 and/or redirecting the user computer 16 back to the third-party computer site 14 with an error code embedded in the URL.

The aforementioned validation acts are to thwart replay attempts and other attacks. The second request 40 is deemed to be completely validated if the time stamp is acceptable, if the information is valid, and if the user computer 16 has an active session and/or has successfully logged in using the login user interface. Once the second request 40 is completely validated, the network service provider 34 performs actions needed to carry out the request. For example, the Web server 36 can send an initiate command 42 to a service element 44 to initiate the network service 12. The initiate command 42 can be through a Web service request between the Web server 36 and the service element 44. The service element 44 may be an underlying network server.

For purposes of illustration and example, the user 10 has an IP telephone 46 in his/her home or office as a VoIP endpoint to a VoIP service provided by the network service provider 34. The user 10 clicks on the control 26 to initiate a click-to-call from the page 20 provided by the third-party computer site 14. The Web server 36 provides a VoIP Web interface, and the server element 44 and other server elements 48 provide IP telephony functions. The network service provider 12 initiates a VoIP phone connection for the IP telephone 46 of the user 10, and dials a particular telephone number encoded in the second request 40. In this way, the user 10 is enabled to initiate a click-to-call from the third-party computer site 14, while remaining anonymous to the third-party computer site 14, and to conduct the call using his/her IP telephone 46.

The network service provider 34 sends a second redirect message 50 to redirect the user computer 16 to the third-party computer site or another return address encoded in the second request 40. The user computer 16, in turn, automatically sends a third request 52 to the third-party computer site 14 in response to the second redirect message 50. The URL provided in the second redirect message 50 may comprise additional information appended thereto or otherwise included therewith by the network service provider 54. The additional information may comprise one or more status codes indicating a status of the action, and/or one or more error codes indicating any errors associated with the action. This additional information is forwarded to the third-party computer site 14 in the third request 52.

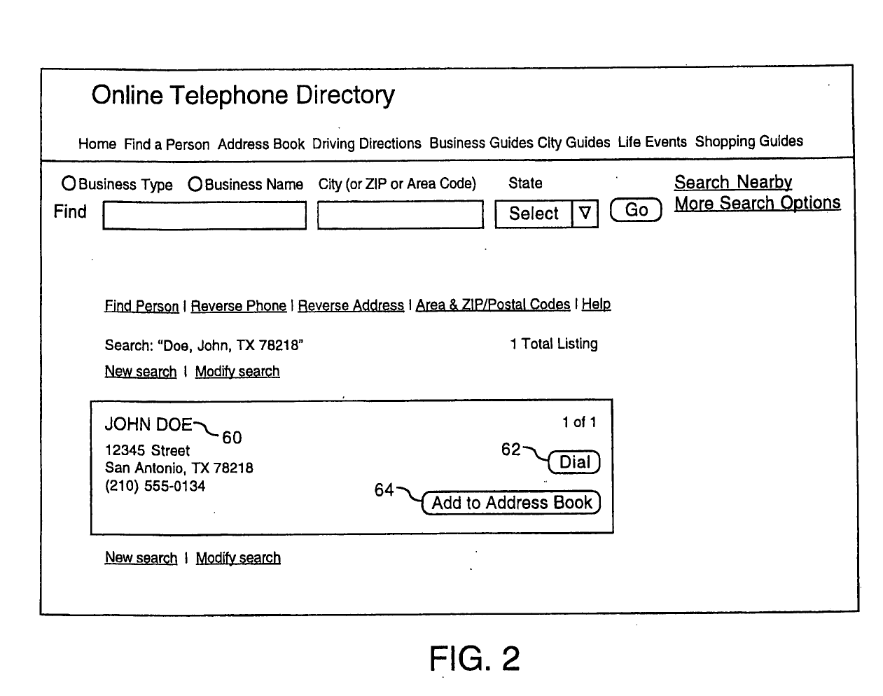

FIG. 2 is a screen shot of an embodiment of the Web page 20 provided by the third-party computer site 14. At the time the Web page 20 is provided to the user computer 16, the user 10 has not logged in to the third-party computer site 14. The user 10 may be anonymous to the third-party computer site 14.

The Web page 20 is returned to the user computer 16 in response to the user 10 initiating a search using the third-party computer site 14. The search may be for a particular person and/or his/her telephone number. For purposes of illustration and example, the third party provides telephone directory functions such as Yellow Pages and White Pages directory functions, but is not a VoIP service provider. In contrast, the network service provider 34 provides either a consumer or a business VoIP service for the user 10.

The Web page 20 displays a name 60 of a person found in the search, a click-to-dial button 62 and an add-to-address-book icon 64. Using the method of FIG. 1, the user 10 can click on the click-to-dial button 62 to automatically dial the telephone number of the person and use the IP phone 46 to conduct a VoIP telephone call with the person. Either alternatively or additionally, the user 10 can click on the add-to-address-book icon 64 to automatically add this directory entry to the user's personal address book.

Optionally, the Web page 20 displays an indication of which network service provider is to provide the VoIP telephone call in response to the selection of the click-to-dial button 62, and which network service provider is making its stored address book modifiable in response to a selection of the add-to-address-book icon 64.

For purposes of illustration and example, consider the user 10 clicking on the click-to-dial button 62 to initiate dialing of 210-555-0134. This action by the user 10 causes the first request 30 to be sent to the third-party computer site 14. The third-party computer site 14 generates the redirect message 32 in the form of the following URL:

http://voip.sbc.com/WebService?action=“dial”&affiliate=“AbcxyzPages”&timestamp
=“20050714182559”&number=“2105550134”&return=“http://www.abcxyzpages.co
m/...”&signature=“2d234f0cf04335cv0af02da6f9bf9d80995a1d9c”.

The requesting Web server sends the dial request to the network service provider through the browser as a redirect message to the above URL. That is, the Web browser 24 receives the redirect message (that includes the above URL) from the third-party computer site 14, and passes the URL through HTTP to the Web server 36 of the network service provider 34.

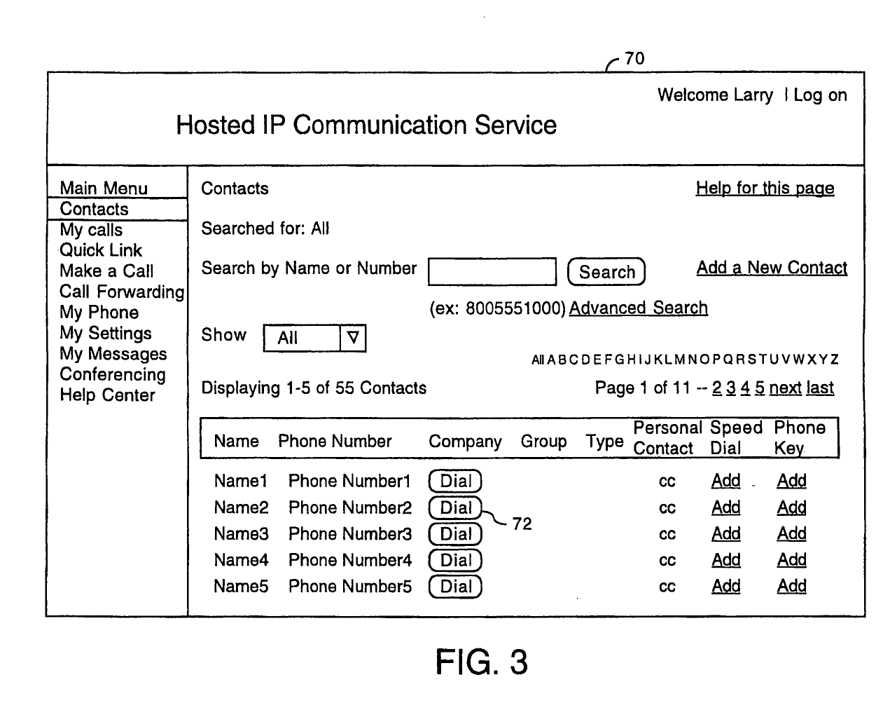

Embodiments of the method also can be used for a computer site provided by the same party as the network service provider 34 instead of a third party. FIG. 3 is a screen shot of an embodiment of a Web page 70 provided by the same party as the network service provider, but at a different site and/or server. The Web page 70 is a landing page for a hosted IP communication service. Each of a plurality of names on the page has an associated dial button. By clicking on a dial button 72, a VoIP customer can automatically initiate a call from his/her VoIP telephone to the number listed in the address book using the method of FIG. 1. In this example, the user is not anonymous to the computer site that provides the Web page 70.

Although described at times in the context of a click-to-call service, the teachings herein apply to other network-based services and Web sites. The services can be initiated on behalf of a user from a partner's Web site, an affiliate's Web site, or a Web-based enterprise application for an enterprise customer.

Although the click-to-call service is described for placing a VoIP call, the teachings herein can be modified to place other types of telephone calls including but not limited to traditional wireline and/or wireless telephone calls in wireline and/or wireless telephone carrier networks. Another variation is to use the teachings herein to place telephone calls in either a Private Branch Exchange (PBX) or an IP-PBX.

Further, the teachings herein can be modified to enable a company to integrate its internal address books (e.g. a Web-based employee locator) with a vendor-supplied Customer Premise Equipment (CPE)-based PBX or IP-PBX. In this case, the computer site 14 provides the Web-based employee locator, and the Web server 36 sends the initiate command 42 to an element of the PBX or IP-PBX. In this way, users can initiate telephone calls by clicking on a page provided by the Web-based employee locator computer site. Integration is simplified using the teachings herein.

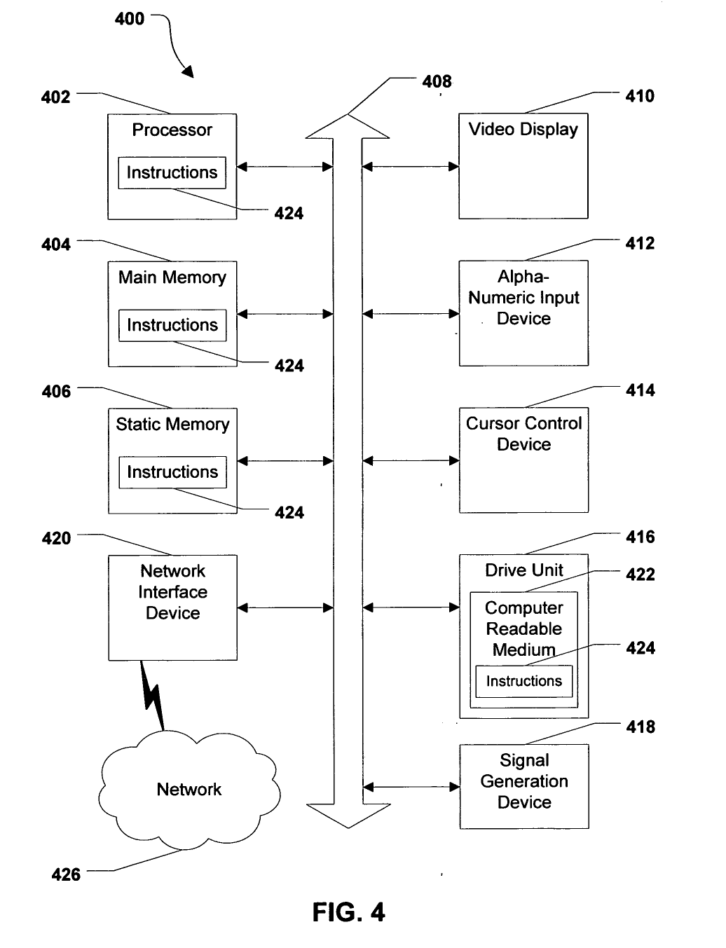

Referring to FIG. 4, an illustrative embodiment of a general computer system is shown and is designated 400. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. In a particular embodiment, one or more of the computers or servers described in conjunction with FIG. 1 can include one or more of the elements illustrated in FIG. 4.

In a networked deployment, the computer system may operate in the capacity of a server or as a client user computer in a server-client user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. Moreover, the computer system 400 can include a main memory 404 and a static memory 406, that can communicate with each other via a bus 408. As shown, the computer system 400 may further include a video display unit 410, such as a liquid crystal display (LCD), an organic light emitting diode (OLED), a flat panel display, a solid state display, or a cathode ray tube (CRT). Additionally, the computer system 400 may include an input device 412, such as a keyboard, and a cursor control device 414, such as a mouse. The computer system 400 can also include a disk drive unit 416, a signal generation device 418, such as a speaker or remote control, and a network interface device 420.

In a particular embodiment, as depicted in FIG. 4, the disk drive unit 416 may include a computer-readable medium 422 in which one or more sets of instructions 424, e.g. software, can be embedded. Further, the instructions 424 may embody one or more of the methods or logic as described herein. In a particular embodiment, the instructions 424 may reside completely, or at least partially, within the main memory 404, the static memory 406, and/or within the processor 402 during execution by the computer system 400. The main memory 404 and the processor 402 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 424 or receives and executes instructions 424 responsive to a propagated signal, so that a device connected to a network 426 can communicate voice, video or data over the network 426. Further, the instructions 424 may be transmitted or received over the network 426 via the network interface device 420.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing a network service to a user via a third-party computer site, the method comprising:
(a) providing, to a user computer, access to a page from the third-party computer site without a login;
(b) sending a first request from the user computer to the third-party computer site in response to a user-initiated action made using the page;
(c) receiving, by the third-party computer site, the first request;
(d) generating a first redirect message based on the first request, the first redirect message to redirect the user computer to a server, the first redirect message encoding information that comprises a time stamp, the first redirect message further encoding a digital signature generated based on the information;
(e) sending the redirect message from the third-party computer site to the user computer;
(f) receiving, by the server from the user computer, a second request caused by the first redirect message; and
(g) based on the second request:
(g1) determining that the user computer has an active session with the server;
(g2) determining that the information encoded in the second request is valid based on the digital signature; and
(g3) directing a service element to initiate the network service based on (g1) and (g2).

2. The method of claim 1, wherein the user-initiated action comprises a click of a button on the page.

3. The method of claim 1, wherein the information encoded in the first redirect message further comprises a telephone number.

4. The method of claim 3, wherein the network service comprises placing a telephone call to the telephone number.

5. The method of claim 3, wherein the network service comprises adding the telephone number to an address book.

6. The method of claim 1, wherein the information encoded in the first redirect message further comprises an action value that identifies the network service from a plurality of different network services.

7. The method of claim 5, wherein the network services further comprises at least one of the following: a click-to-call service, an add-to-address-book service, an initiate download service, and a modify bandwidth on demand service.

8. The method of claim 1, wherein the information encoded in the first redirect message further comprises a return address, the method further comprising:
(h) sending a second redirect message from the server to the user computer, the second redirect message to redirect the user computer to the return address.

9. The method of claim 8, wherein the return address is at the third-party computer site.

10. The method of claim 1, wherein the information encoded in the first redirect message further comprises an identifier of the third party.

11. The method of claim 1, wherein (d) comprises:
(d1) generating the digital signature by encrypting the information.

12. The method of claim 11, wherein (g2) comprises comparing the information to a decryption of the digital signature.

13. The method of claim 11, wherein (g2) comprises encrypting the information received by the server in the second request and comparing the encrypted information to the digital signature.

14. The method of claim 11, wherein (d1) comprises applying a one-way hash algorithm to the information using a shared secret of the third-party computer site and the server.

15. The method of claim 1, wherein (g1) comprises performing a cookie exchange between the server and the user computer.

16. The method of claim 1, further comprising, if the session does not exist between the user computer and the server:
(g4) providing a login user interface to the user computer;
(g5) authenticating the user based on an input made to the login user interface; and
(g6) directing the service element to initiate the network service based on said authenticating the user.

17. The method of claim 1, wherein the first redirect message comprises a Uniform Resource Locator (URL) of the server, the URL including the information and the digital signature.

18. The method of claim 17, wherein the information further comprises an action value, an identifier of the third-party computer site, and a return URL.

19. The method of claim 18, wherein the information further comprises a telephone number.

20. The method of claim 1, wherein (g3) is further based on determining that a difference between the time stamp and a current time is acceptable.

21. A method of initiating a telephone call for a user via a computer site, the method comprising:
(a) providing, to a user computer, access to a page from the computer site;
(b) sending a first request from the user computer to the computer site in response to a user-initiated action made using the page;
(c) receiving, by the computer site, the first request;
(d) generating a first redirect message based on the first request, the first redirect message to redirect the user computer to a server, the first redirect message encoding information that comprises a time stamp, the first redirect message further encoding a digital signature generated based on the information;
(e) sending the redirect message from the computer site to the user computer;
(f) receiving, by the server from the user computer, a second request caused by the first redirect message; and
(g) based on the second request:
(g1) determining that the user computer has an active session with the server;
(g2) determining that a difference between the time stamp and a current time is acceptable;
(g3) determining that the information encoded in the second request is valid based on the digital signature; and
(g4) directing a service element to initiate the telephone call for the user based on (g1), (g2) and (g3).

22. The method of claim 21, wherein the telephone call is a Voice over Internet Protocol (VoIP) telephone call.
